(19) United States
(12) Patent Application Publication
(10) Pub. No.: US 2005/0065673 A1
(43) Pub. Date: Mar. 24, 2005

(54) Configurable remote control system for a locomotive

(75) Inventors: Folkert W. Horst, Pierrefonds (CA); Oleh Szklar, St-Hubert (CA); Brigide Mattar, Ville Mont-Royale (CA); Emma Start, Montreal (CA)

Correspondence Address: Mr. William R. Evans;LADAS & PARRY, 26 West 61st Street, New York, NY, 10023-7604, US

(73) Assignee: CANAC INC.

(21) Appl. No.: 10/667,641

(22) Filed: Sep. 22, 2003

(51) Int. Cl. B61L 27/00; G06F 17/00

(52) U.S. Cl. 701/19; 246/2 R; 701/2

(57) ABSTRACT

The invention provides a remote control device for use in a locomotive remote control system that has a locomotive control device mounted on a locomotive. The remote control device comprises a first input, a second input, a processing unit and a transmission unit. The first input receives a signal conveying a command. The second input receives configuration information. The processing unit is in communication with the first input and the second input for acquiring a certain set of operational settings on the basis of the configuration information. The processing unit further generates digital command signals conveying command data to the locomotive control device on the basis of the signal received at the first input and the certain set of operational settings. The transmission unit is operative for generating an RF transmission for conveying the digital command signals to the locomotive control device.

### FIELD OF THE INVENTION

The present invention relates to a locomotive remote control system. More particularly, the present invention relates to a locomotive remote control system that can be configured.

### BACKGROUND OF THE INVENTION

Remote control systems for controlling locomotives are known in the art. Typically, remote control systems for locomotives have two main components, namely a remote control device and a locomotive control device. The remote control device is operative for receiving signals from a user conveying commands to be transmitted to the locomotive control device. The locomotive control device is typically mounted on board the locomotive and is adapted for receiving the command signals sent by the remote control device over a wireless communication link.

When an operator wishes to cause a movement of the locomotive in a certain direction, or at a certain speed, for example, he or she manipulates the controls on the remote control device in order to specify the desired parameters (i.e. forward, backwards, speed, etc . . . ). The parameters are encoded into a command signal, which is then sent by the remote control device to the locomotive control device. The locomotive control device processes the command signal and issues local control signals to a control interface for causing the desired commands to be implemented by the locomotive.

A deficiency with existing locomotive remote control systems is that they are not suitable for readily controlling the locomotive in different environments. For example, a locomotive control system used in one switch yard may not be suitable for use in another switch yard due to varying, and possibly incompatible, requirements regarding communication conventions, speed limits and so on. As such, in order to be able to control a locomotive in different situations, and under different conditions, different locomotive remote control systems are needed. This is both expensive and inconvenient for owners and operators of railroad systems.

In the context of the above, it can be seen that there is a need in the industry to provide a locomotive remote control system that alleviates, at least in part, the problems associated with existing locomotive remote control systems.

### SUMMARY OF THE INVENTION

In accordance with a first broad aspect, the present invention provides a remote control device suitable for use in a locomotive remote control system that has a locomotive control device mounted on board a locomotive. The remote control device comprises a first input, a second input, a processing unit and a transmission unit. The first input receives a signal from a user conveying a command and the second input receives configuration information. The processing unit is in communication with the first input and the second input and is adapted for acquiring a certain set of operational settings on the basis of the configuration information. The processing unit is further adapted for generating digital command signals on the basis of the signal received at the first input and on the basis of the certain set of operational settings. The digital command signals convey the command data to the locomotive control device. The transmission unit is in communication with the processing unit for receiving the digital command signals and for generating an RF transmission conveying the digital command signals to the locomotive control device.

In accordance with another broad aspect, the present invention provides a locomotive control device that is suitable for use in a locomotive remote control system. The locomotive control device is adapted for being mounted in a locomotive that has a control interface. The locomotive control device comprises a first input, a second input, a processing module and a transmission module. The first input receives from a remote control device a signal conveying a command. The second input receives configuration information. The processing module is in communication with the first input and the second input and is adapted for acquiring a certain set of operational settings on the basis of the configuration information. In addition, the processing module is adapted for generating local control signals on the basis of the signal received at the first input and on the basis of the certain set of operational settings. The local control signals convey a command to be implemented by the control interface. The transmission module is in communication with the processing module for receiving the local control signals and for transmitting the local control signals to the control interface.

In accordance with another broad aspect, the present invention provides a remote control device suitable for use in a locomotive remote control system that has a locomotive control device mounted on board a locomotive. The remote control device comprises a user interface, an input and a processing unit. The user interface enables a user to enter a signal conveying a command and for receiving configuration information. The processing unit is adapted for causing the user interface to acquire a certain set of display settings on the basis of the configuration information.

In accordance with yet another broad aspect, the present invention provides a locomotive remote control system that comprises a remote control device and a locomotive control device. The remote control device includes a first input, a second input, a processing unit and a transmission unit. The first input receives a signal from a user conveying a command. The second input receives configuration information. The processing unit is in communication with the first input and the second input and is adapted for acquiring a set of operational settings on the basis of the configuration information. In addition, the processing unit is operative for generating digital command signals on the basis of the signal received at the first input and on the basis of the set of operational settings. The digital command signals convey command data to the locomotive control device. The transmission unit is in communication with the processing unit for receiving the digital command signals and for generating an RF transmission conveying the digital command signals to the locomotive control device. The locomotive control device is suitable for being mounted on board a locomotive and comprises an input for receiving the digital command signals and a processing module for generating local control signals for causing the locomotive to execute the commands conveyed by the digital command signals.

In accordance with another broad aspect, the present invention provides a remote control device suitable for use in a locomotive remote control system that has a locomotive control device mounted on board a locomotive. The remote control device comprises input means, processing means and transmission means. The input means receives a signal from a user conveying a command and receives configuration information. The processing means is adapted for acquiring a certain set of operational settings on the basis of the configuration information. The processing means is further adapted for generating digital command signals on the basis of the signal received at the input means and on the basis of the certain set of operational settings. The digital command signals convey the command data to the locomotive control device. The transmission means is in communication with the processing means for receiving the digital command signals and for generating an RF transmission conveying the digital command signals to the locomotive control device.

In accordance with another broad aspect, the present invention provides a remote control device suitable for use in a locomotive remote control system that has a locomotive control device mounted on board a locomotive. The remote control device comprises a first input, a second input, a processing unit and a transmission unit. The first input receives from a user a signal conveying a command. The second input receives configuration information. The processing unit is in communication with the first input and the second input and is adapted for acquiring a certain set of switchyard operational settings on the basis of the configuration information. The processing unit is further adapted for generating digital command signals on the basis of the signal received at the first input and the certain set of switchyard operational settings. The digital command signals convey command data to the locomotive control device. The transmission unit is operative for receiving the digital command signals and for generating an RF transmission conveying the digital command signals to the locomotive control device.

In accordance with yet another broad aspect, the present invention provides a remote control device suitable for use in a locomotive remote control system that has a locomotive control device mounted on board a locomotive. The remote control device comprises a first input, a second input, a processing unit and a transmission unit. The first input receives a signal from a user conveying a command and the second input receives configuration information. The processing unit is adapted for acquiring a certain set of user related operational settings on the basis of the configuration information, and for generating digital command signals on the basis of the signal received at said first input and the certain set of user related operational settings. The digital command signals convey command data to the locomotive control device. The transmission unit receiving the digital command signals and generates an RF transmission for conveying the digital command signals to the locomotive control device.

In accordance with yet another broad aspect, the present invention provides an apparatus suitable for configuring a locomotive remote control system that has a remote control device and a locomotive control device. The apparatus comprises a processing unit and a transmission unit. The processing unit stores configuration information relating to at least one set of operational settings. The transmission unit establishes a communication link with the remote control device and transmits the configuration information to the remote control device over the communication link. The configuration information causes the remote control device to acquire a certain set of operational settings.

In accordance with yet another broad aspect, the present invention provides an apparatus suitable for configuring a locomotive remote control system that has a remote control device and a locomotive control device. The apparatus comprises a processing unit and a transmission unit. The processing unit stores configuration information relating to at least one set of operational settings. The transmission unit establishes a communication link with the locomotive control device and transmits the configuration information to the locomotive control device over the communication link. The configuration information causes the locomotive control device to acquire a certain set of operational settings.

### BRIEF DESCRIPTION OF THE DRAWINGS

In the accompanying drawings:

FIG. 1 shows a high-level block diagram of a locomotive remote control system in accordance with a specific example of implementation of the present invention;

FIG. 2A shows a first specific example of a physical implementation of a remote control device in accordance with the present invention;

FIG. 2B shows a second specific example of a physical implementation of a remote control device in accordance with the present invention;

FIG. 3 shows a functional block diagram of a locomotive remote control system in accordance with a first specific example of implementation of the present invention;

FIG. 4 shows a functional block diagram of a locomotive remote control system in accordance with a second specific example of implementation of the present invention;

FIG. 5 shows a functional block diagram of a locomotive remote control system in accordance with a third specific example of implementation of the present invention;

FIG. 6 shows a flow chart of a process implemented by the locomotive remote control system of FIG. 3 in accordance with a specific example of implementation of the present invention;

FIG. 7 shows a flow chart of a process implemented by the locomotive remote control system of FIG. 4 in accordance with a specific example of implementation of the present invention;

FIG. 8 shows a flow chart of a process implemented by the locomotive remote control system of FIG. 5 in accordance with a specific example of implementation of the present invention.

FIG. 9 shows a computing unit in accordance with a specific example of implementation of the present invention.

Other aspects and features of the present invention will become apparent to those ordinarily skilled in the art upon review of the following description of specific embodiments of the invention in conjunction with the accompanying figures.

### DETAILED DESCRIPTION

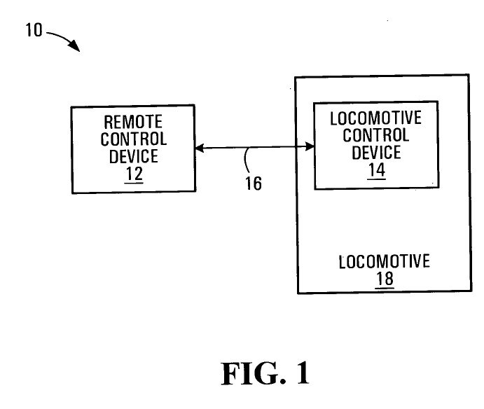

Shown in FIG. 1 is a high-level block diagram of a remote control system 10 in accordance with a specific example of implementation of the present invention. The remote control system 10 includes two main components, namely a remote control device 12 and a locomotive control device 14, which is suitable for being mounted on board a locomotive 18. The remote control device 12 and the locomotive control device 14 are linked to one another via a wireless communication link 16.

In a specific example of implementation, the remote control device 12 is a portable unit that is adapted for being carried by a human operator located remotely from the locomotive 18. It should however be understood that in an alternative example of implementation, the remote control device 12 can be a stationary unit that is mounted at a remote location from the locomotive 18, such as in a control tower or in an operator station.

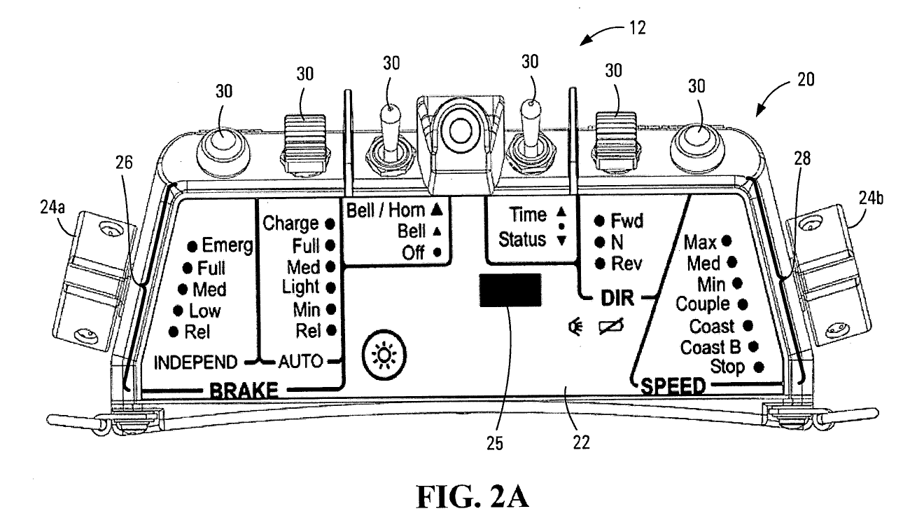

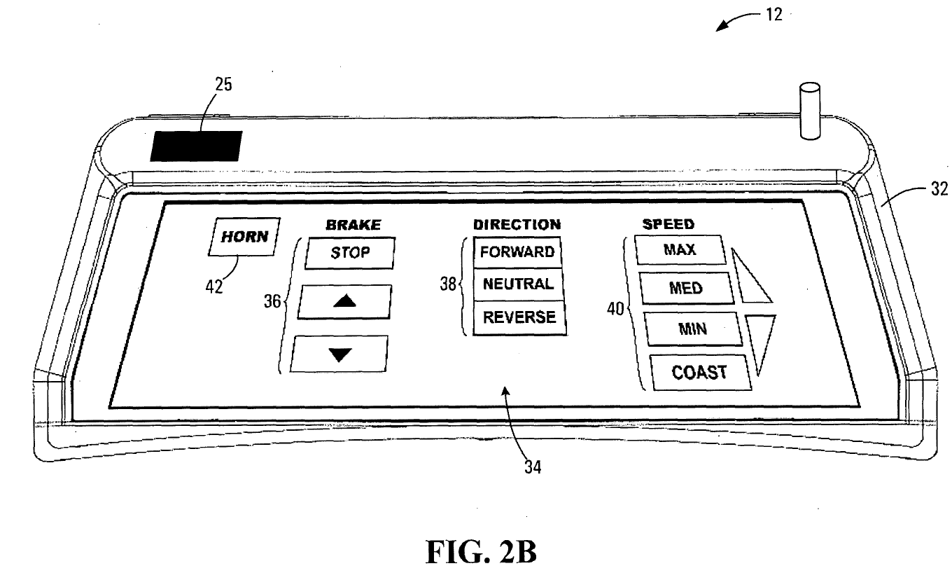

Shown in FIGS. 2A and 2B are two specific, non-limiting, examples of physical layouts of the remote control device 12. The remote control device 12 shown in FIG. 2A is in the form of a portable unit that includes a housing 20 for enclosing the electronic circuitry, a battery for supplying electrical power (not shown) and a user interface 22 having multiple user-operable-inputs. In the specific embodiment shown, the user interface 22 includes two dials 24a and 24b located on either side of the housing 20, that are able to be manipulated by a user in order to enter signals conveying commands. Specifically, by manipulating dial 24a located on the left, the user is able to enter brake commands. The brake command information is displayed to the user via display portion 26 shown on the front of the housing 20. By manipulating dial 24b located on the right, the user is able to enter speed commands. The speed command information is displayed to the user via display portion 28 shown on the front of the housing 20. Other commands, such as on/off, bell/horn activation and forward/reverse, can be entered via control knobs and inputs 30 located on the upper portion of the housing 20.

Shown in FIG. 2B is an alternative example of a physical implementation of a remote control device 12. The remote control device 12 shown in this figure is also in the form of a portable unit, and includes a housing 32 for enclosing the electronic circuitry, a battery for supplying electrical power (not shown) and a user interface 34 in the form of a graphical user interface that includes a touch sensitive screen for presenting user-operable-inputs to a user. The touch sensitive screen includes user-operable-inputs 36 that enable a user to enter brake information, user-operable-inputs 38 that enable a user to enter direction information, and user-operable-inputs 40 that enable a user to enter speed information. More specifically, the braking user-operable-inputs 36 enable a user to bring the train to a stop, increase braking and decrease braking. The direction user-operable-inputs 38 enable a user to direct the locomotive to move in the forward direction, the reverse direction and to remain in neutral. The speed user-operable-inputs 40 enable a user to control the speed of the locomotive by entering a max speed command, a medium speed command, a minimum speed command and a coast command. It should be understood that these speed user-operable-inputs might indicate specific speed values, instead of “min”, “med” and “max”. The user interface 34 further includes a user-operable-input 42 that enables a user to activate a bell or horn.

Although two different physical implementations of a remote control device 12 have been described above, it should be understood that the physical implementation of the remote control device 12 can vary greatly without departing from the spirit of the invention. For example, the user interfaces 22 and 34 can include other user-operable-inputs such as keyboards, inputs, levers, dials, a voice recognition unit, a pointing device or any other suitable user-operable-input device known in the art. In addition, both of the remote control devices 12 shown in FIGS. 2A and 2B can include additional or fewer user-operable-inputs without departing from the spirit of the invention.

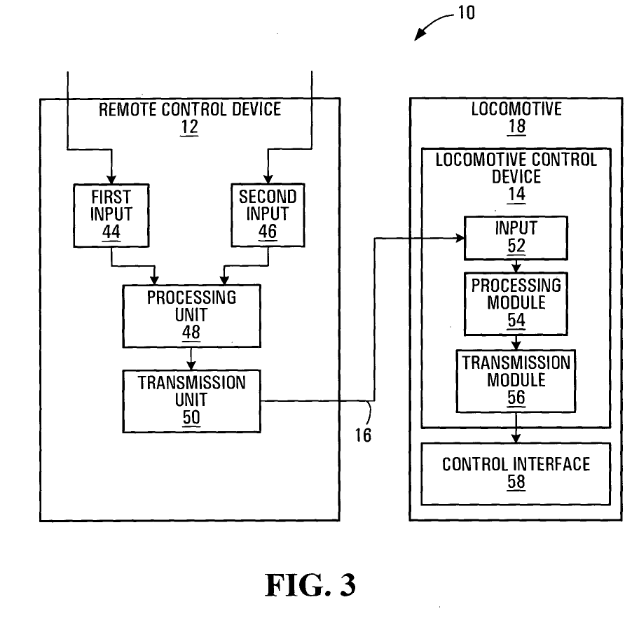

Shown in FIG. 3 is a functional block diagram of a locomotive remote control system 10 in accordance with a first specific example of implementation of the present invention. As shown, the remote control device 12 includes a first input 44, a second input 46, a processing unit 48 and a transmission unit 50. As mentioned above, the remote control device 12 is in communication with the locomotive control device 14 over a wireless communication link 16. Preferably, the wireless communication link 16 is an RF communication link, however, in an alternative embodiment, the wireless communication link 16 can be an infrared communication link.

In the specific embodiment shown in FIG. 3, the locomotive control device 14, which is mounted at the locomotive 18, includes an input 52, a processing module 54 and a transmission module 56 that is in communication with the control interface 58 of the locomotive 18.

As used for the purposes of the present application, the term “control interface 58” refers globally to the collection of various actuators located on the locomotive for executing various control signals issued by the transmission module 56 of the locomotive control device 14. Examples of such actuators include the actuators that control the throttle, and the brakes, among others.

The first input 44 of the remote control device 12 is adapted for receiving signals from a user conveying a command. The signals for conveying commands can be entered via the user-operable inputs of the remote control device 12, as described above with reference to FIGS. 2A and 2B. Once the user has entered signals conveying commands at the first input 44, the signals are forwarded to the processing unit 48. As described above, the signals can convey commands relating to direction, speed, throttle, braking, and horn activation, among others.

In the specific example of implementation shown in FIG. 3, the remote control device 12 further includes a second input 46 that is adapted for receiving configuration information. Upon receipt of the configuration information at second input 46, the configuration information is forwarded to the processing unit 48, which, on the basis of the configuration information, acquires a set of operational settings.

In a specific implementation, the processing unit 48 acquires a set of operational settings by assigning specific settings or values to one or more configurable operational settings of the locomotive remote control system 10. In a specific example of implementation, the set of operational settings can be switchyard operational settings such as the specific frequency over which signals are transmitted, whether the transmission operates in a TDMA or CDMA mode, locomotive response rate, brake pipe pressure, a repetition rate or a range of repetition rates and clock information for dictating the timing that signals are transmitted. In an alternative implementation, the set of operational settings can be user related operational settings that relate to a specific users operational setting preferences or that relate to operational settings associated to the user's permission level. For example, some non-limiting user related operational settings include the soft function key assignments, switchyard ID, the display mode, the language of the talker mode, the speed settings, such as the specific speeds associated to the max, med, and min speeds indicated on the user interface 22, the enabling or disabling of the locomotive's automatic pilot mode, and the type of sound assigned to the horn, among others. It should be understood that other configurable operational settings are also included within the scope of the present invention.

In a first specific example of implementation, the configuration information received at input 46 includes programming information that is operative for modifying a default set of operational settings. In the specific example of implementation shown in FIG. 3, the default set of operational settings is stored in a memory (not shown in the Figures) associated to the processing unit 48, such that the processing unit 48 acquires a desired set of operational settings upon receipt of the configuration information. Those skilled in the art should appreciate that the programming information may be written in a number of programming languages for use with many computer architectures or operating systems. For example, some embodiments may be implemented in a procedural programming language (e.g., “C”) or an object oriented programming language (e.g., “C++” or “JAVA”). In a further embodiment, the programming information may include data indicative of a new set of operational settings for replacing the set of operational settings being used by the processing unit 48.

In a second specific example of implementation, the configuration information received at the second input 46 is selection information that is operative for selecting a desired set of operational settings from a plurality of sets of operational settings. In the specific example of implementation shown in FIG. 3, the plurality of sets of operational settings are stored in the memory of the processing unit 48, such that the processing unit 48 is able to acquire the selected set of operational settings upon receipt of the configuration information.

It should be understood that the configuration information received at second input 46 can be in the form of a wireless signal, such as an RF signal or an infrared signal. In the specific examples of implementation shown in FIGS. 2A and 2B, the remote control devices 12 include a radio frequency/infrared receiver 25 for receiving wireless signals. In an alternative embodiment of the remote control device 12, the second input 46 can be a port for allowing the remote control device 12 to be connected to a programming device via a cable, or via a docking port in order to receive the configuration information over a wire-line communication link. For example, an apparatus that comprises a processing unit and a transmission unit can be used to establish a wire-line connection with the remote control device. The processing unit could store configuration information relating to at least one set of operational settings and the transmission unit could establish a communication link with the second input 46 of the remote control device in order to transmit that configuration information to the remote control device. The communication link established by the apparatus could also be an RF or infrared link.

In another embodiment, the second input 46 can be a device for reading the configuration information from a computer readable storage medium, such as a disk or CD. In yet another embodiment, the configuration information can be entered via the user-operable-inputs located on the user interface of the remote control device 12, such as through a keyboard, for example.

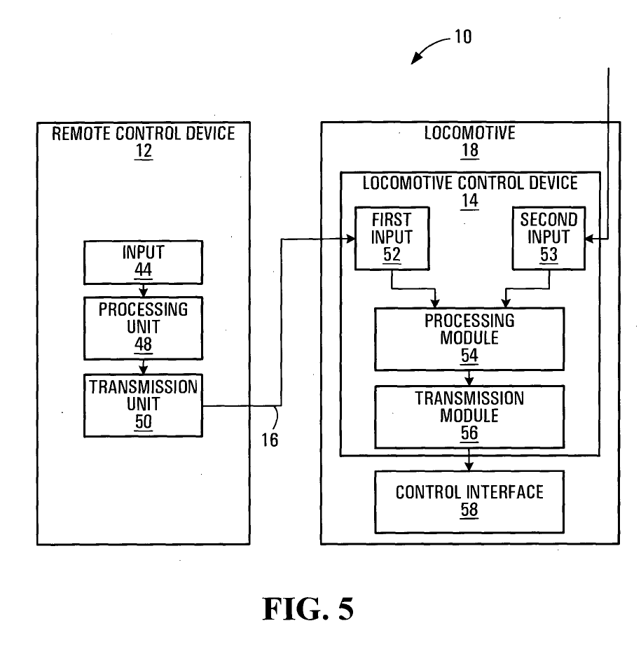

As will be described in more detail below with respect to FIG. 5, in another embodiment of the remote control system 10, the second input 46 can be an antenna adapted for receiving a signal from a transponder.

In the specific case where the configuration information is in the form of selection information, the configuration information can be entered by activating a combination of user-operable inputs located on the user interface of the remote control device 12. For example, in order to select a first set of operational settings, the user could activate a combination of user-operable-inputs located on the remote control device 12, such as the horn input and the reverse input. Then, in order to select a second set of operational settings, the user could activate a different combination of user-operable-inputs, such as the horn input and the max speed input.

Alternatively, when the configuration information is in the form of selection information, additional user-operable-inputs could be located on the user interface of the remote control device 12 for enabling a user to select a set of operational settings. Although not described above with respect to FIGS. 2A and 2B, in a specific example of implementation, the user interface of the remote control device 12 may include inputs indicating “configuration 1”, “configuration 2” or “configuration 3”, that are each associated to a respective set of operational settings. As such, in order to select one of the sets of operational settings, a user must simply activate one of these three inputs.

In the specific example shown in FIG. 3, once the processing unit 48 has received configuration information and has acquired a set of operational settings, the processing unit 48 generates digital command signals for conveying command data to the locomotive control device 14. The processing unit 48 generates the digital command signals at least in part on the basis of the signals received at the first input 44 and on the basis of the set of operational settings. As such, for the same signal that is entered at input 44, the digital command signals generated by the processing unit 48 could be different depending on the set of operational settings acquired by the processing unit 48. For example, if a user enters a signal indicative of max speed at first input 44, and the processing unit 48 has acquired a first set of operational settings, the processing unit 48 may generate a digital command signal for conveying to the locomotive that it should travel at 100 km/hr. However, when a user enters the same signal at the first input 44 indicative of max speed, and the processing unit 48 has acquired a different set of operational settings, the processing unit 48 may generate a digital command signal for conveying to the locomotive that it should travel at 10 km/hr. As such, the processing unit 48 processes the signal received at the first input 44 on the basis of the certain set of operational setting associated to the processing unit 48 at that time. When the set of operational settings changes, so does the corresponding command data generated by the processing unit 48.

As such, since the processing unit 48 can acquire a variety of different sets of operational settings, the remote control device 12 can be configured such that the locomotive remote control device 10 is suitable for use in a variety of different situations. For example, the remote control device 12 can be configured such that the locomotive remote control system 10 is rendered suitable for use by a specific operator, in a specific location, or at a specific time of day. Advantageously, this makes the locomotive remote control system 10 in accordance with the present invention more versatile than traditional locomotive remote control systems.

In a non-limiting example of implementation, the configuration information received at second input 46 is operative for causing the processing unit 48 to acquire a set of user related operational settings that configures the remote control device 12 such that the locomotive remote control system 10 is suitable for use by an individual operator. When the locomotive remote control system 10 is suitable for use by an individual operator, the configurable operational settings are tailored towards the specific preferences, or permission level of an individual operator. For example, for a first operator, the specific speed associated to the max speed setting might be 50 km/hr and the sound associated to the horn might be relatively quiet. Meanwhile, for a different operator, the specific speed associated to the max speed setting might be 100 km/hr and the sound associated to the horn might be relatively loud.

Optionally, in the case where the configuration information causes the processing unit 48 to acquire a set of user related operational settings that renders the locomotive remote control system 10 suitable for use by an individual operator, the user interface 22/34 might include inputs indicating the names of the individual operators, such as “Bob”, “Mary” and “Joe”. As such, in order to enter configuration information to select the set of operational settings that would cause the locomotive remote control system 10 to be suitable for use by the individual operator named “Bob”, a user would simply need to select the “Bob” input.

Although not described above, in a further example of implementation where the configuration information is in the form of selection information for causing the processing unit 48 to acquire a set of user related operational settings, the configuration information can be indicative of user identification data. For example, the user identification data could include a personalised pass-code, fingerprint information, DNA information, voice print and/or retinal information. In such cases, the second input 46 would include the necessary hardware and software module to receive such user identification data.

In a specific example of implementation, in the case where the configuration information conveys user identification data, the processing unit 48 includes a memory (not shown) for storing a database containing user identification data belonging to individual operators and mapping user identification data to corresponding sets of operational settings. Once the configuration information is entered at second input 46, the processing unit 48 is operative for processing the database in order to determine if the user identification data received at second input 46 matches data contained in the database. In the case where there is a match, the processing unit 48 determines the set of operational settings associated to the user identification data and then acquires that set of operational settings in order to configure the remote control device 12 such that the locomotive remote control system 10 is suitable for use by the individual operator that entered the configuration information.

For example, in the specific case where the user identification data conveys fingerprint information, the processing unit 48 includes a database that stores fingerprint information, and maps that fingerprint information to a set of operational settings. As such, upon receipt of fingerprint information from the second input 46, the processing unit 48 processes the entries in the database to determine if the received fingerprint information matches fingerprint information contained in the database. In the case where a match is found, the processing unit 48 determines the set of operational settings associated with that fingerprint information and acquires that set of operational settings. However, if no match is found, the processing unit 48 acquires, or remains with, a default set of operational settings. It should be understood that processing unit 48 may use any suitable fingerprint-matching algorithm and the present invention is not limited to the specific algorithm used for performing fingerprint matching. Such algorithms are known in the art of fingerprint processing and as such will not be described in more detail herein.

Similar systems may be implemented using biometric information other than fingerprint information, such as, but not limited to, voice recognition, DNA data, retinal scan and body shape/pattern data.

Alternatively, in the specific case where the user identification data is a pass code, the processing unit 48 includes a database that stores a plurality of pass codes, and maps each of those pass codes to a set of operational settings. As such, upon receipt of a pass code from the second input 46, the processing unit 48 processes the entries in the database to determine if the received pass code matches a pass code contained in the database. In the case where a match is found, the processing unit 48 determines the set of operational settings associated with that pass code and acquires that set of operational settings. However, if no match is found, the processing unit 48 acquires, or remains with, a default set of operational settings.

In another non-limiting example of implementation, the configuration information received at second input 46 is operative for causing the processing unit 48 to acquire a set of operational settings that configures the remote control device 12 such that the locomotive remote control system 10 is suitable for use by operators associated with specific permission levels.

In specific, non-limiting examples, when the locomotive remote control system 10 is suitable for use by an operator with a low permission level, the specific speed associated to the max speed setting might be 10 km/hr and the ability to put the locomotive 18 into auto pilot mode might be disabled, and when the locomotive remote control system 10 is suitable for use by an operator with a high permission level, the specific speed associated to the max speed setting might be 100 km/hr and the ability to put the locomotive 18 into auto pilot mode might be enabled.

In another non-limiting example of implementation, the configuration information received at second input 46 is operative for causing the processing unit 48 to acquire a set of operational settings that configures the remote control device 12 such that the locomotive remote control system 10 is suitable for use in a specific geographical location. The specific geographical location may be a country, within a certain switchyard, outside a switchyard or any other desirable location. In a specific exmaple of implementation, the processing unit acquires a set of switchyard operational settings. For example, during travel, locomotives generally start in a first switchyard, travel across railroad tracks that are outside the first switchyard, and then finish in a destination switchyard different from the first switchyard. It is entirely possible that the constraints on the locomotive are different in the first switchyard, outside the switchyard and in the second switchyard. For example, in the first switchyard, it might be desirable to constrain the locomotive to moving at a speed below 15 km/hr. In such a scenario, the processing unit 48 can be configured such that the maximum speed that a can be transmitted to the locomotive control device 14 is 15 km/hr. However, when the locomotive is outside the switchyard, and there are no constraints on the maximum speed that the locomotive is allowed to travel, the processing unit 48 could be configured such that the maximum speed that can be transmitted to the locomotive control device 14 is 200 km/hr. Furthermore, when the locomotive enters the second switchyard, it might be desirable to constrain the locomotive to moving at 10 km/hr, and the transmission frequency might be different from the first switchyard. As such, the processing unit 48 could be configured such that the maximum speed that can be transmitted to the locomotive control device 14 is 10 km/hr, and the transmission frequency can be changed. It should be understood that the speeds provided above are simply for the purpose of example, and do not necessarily reflect accurate speed limits for the locomotive.

In yet a further non-limiting example of implementation, the configuration information received at the second input 46 is operative for causing the processing unit 48 to acquire a set of operational settings that configures the remote control device 12 such that the locomotive remote control system 10 is suitable for use at a certain time of day.

For example, the set of operational settings that configures the locomotive remote control system 10 to be suitable for use during the night might cause the horn to be relatively quiet. This could be done, for example, by using a built-in clock or timer that configures the horn setting on the basis of the time of day.

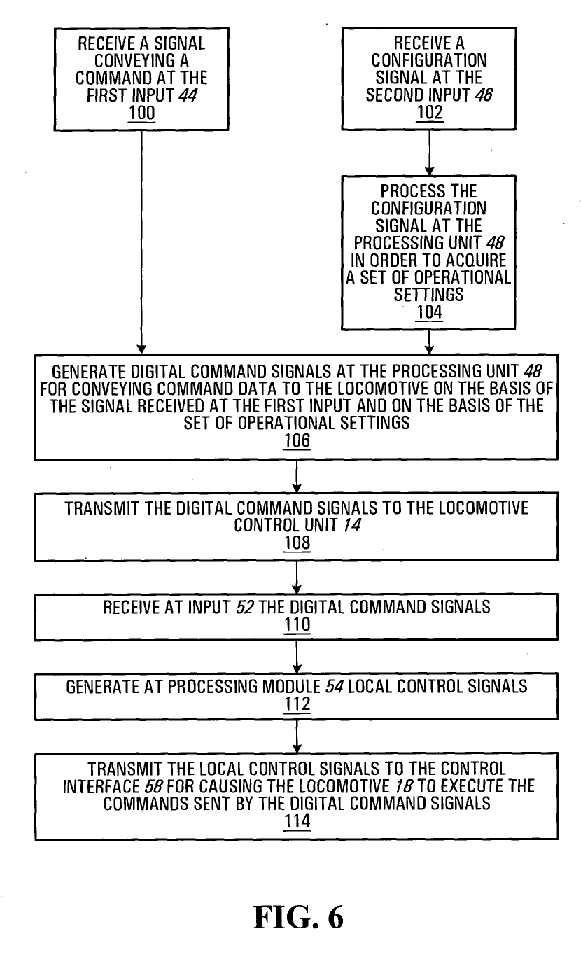

The process used by the locomotive remote control system 10 shown in FIG. 3 will now be described in more detail with respect to the flow chart shown in FIG. 6. At step 100 a signal conveying a command is received from a user at first input 44. At step 102, configuration information is received at the second input 46. At step 104, the processing unit 48 processes the configuration information received at the second input in order to acquire a set of operational settings, that in a specific example of implementation can be switchyard operational settings or user related operational settings.

At step 106, the processing unit 48 generates digital command signals for conveying command data to the locomotive 18, at least in part on the basis of the signal received at the first input and the set of operational settings. At step 108, the transmission unit 50 transmits the digital command signals to the locomotive control device 14, and at step 110, the input 52 of the locomotive control device 18 receives the digital command signals. At step 112, the processing module 54 generates local control signals for conveying the command data generated by the processing unit 48. Finally, at step 114, the transmission module 56 transmits the local control signals to the control interface 58 for causing the control interface 58 to execute the commands conveyed by the command data.

It should be noted that FIG. 6 shows step 100 as being performed independently of steps 102 and 104. In other words, receiving a signal conveying a command at the first input 44 is not necessarily dependent on having received configuration information at the second input 46 and having the processing unit 48 acquire a set of operational settings. It is within the scope of the invention for the remote control device 12 to receive a plurality of commands at the first input 44 and receive configuration information only once at the second input 46.

Referring back to the physical implementation of the remote control device 12 shown in FIG. 2B, and the locomotive remote control system 10 shown in FIG. 3, in an alternative example of implementation, upon receipt of the configuration information, the processing unit 48 is operative for causing the user interface 34 to acquire a set of display settings on the basis of the configuration information. This example of implementation is typically used when the user interface includes a touch sensitive screen, or other interface that is modifiable.

In a specific implementation, the user interface 34 includes a set of modifiable features that may be configured in a certain way. For example, the modifiable features of the display settings that can be configured include the brightness level of the screen, the type and size of font, the types of user-operable-inputs displayed, the values indicated on the user-operable-inputs for entering speed commands, the color of the screen, etc . . . The configuration information received at input 46 allows for the configuring of one or more of the modifiable features.

The configuration information can include programming information that is operative for modifying a default set of display settings, in which case, the default set of operational settings are stored in a memory (not shown) of the processing unit 48. Alternatively, the configuration information can be in the form of selection information that is operative for selecting a desired set of display settings from a plurality of sets of display settings, in which case the plurality of sets of display settings are stored in the memory of the processing unit 48.

In the specific embodiment described above, it is the processing unit 48 of the remote control device 12 that acquires a set of operational settings, or a set of display settings, on the basis of the configuration information.

In an alternative example of implementation, the processing module 54 of the locomotive control device 14 is operative for acquiring a set of operational settings on the basis of the configuration information. As such, it is the locomotive control device 14 that is configurable in order to render the locomotive remote control system 10 suitable for use in a variety of situations.

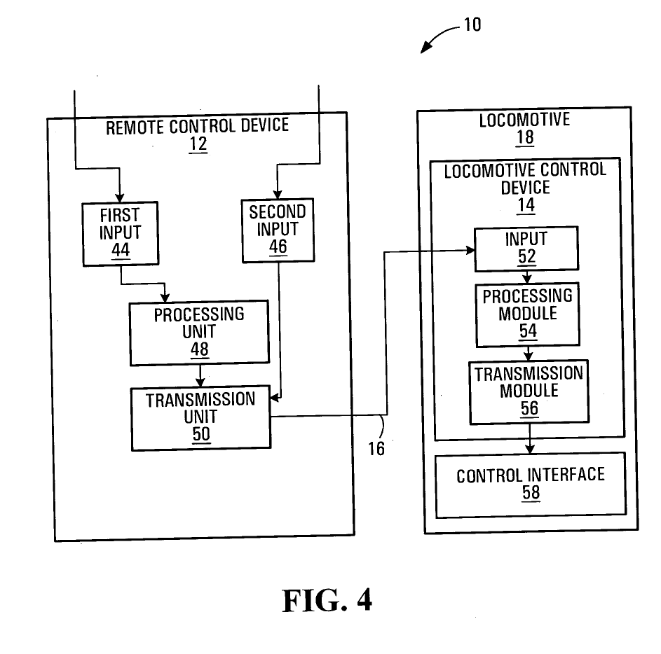

Shown in FIGS. 4 and 5 are two specific embodiments of the locomotive remote control system 10, wherein it is the processing module 54 of the locomotive control device 14 that acquires a set of operational settings on the basis of the configuration information.

In the embodiment of the locomotive remote control system 10 shown in FIG. 4, the remote control device 12 includes a second input 46 for receiving configuration information. Upon receipt of the configuration information at the second input 46, the configuration information is sent to the transmission unit 50, which transmits the configuration information to the locomotive control device 14 over communication link 16. The configuration information is received at the input 52 and is passed to the processing module 54. On the basis of the configuration information, the processing module 54 acquires a set of operational settings that configures the locomotive control device 14 such that the locomotive remote control system 10 is suitable for use in the variety of different situations described above with respect to FIG. 3.

As mentioned above, the configuration information can include programming information that is operative for modifying a default set of operational settings. In the specific example of implementation shown in FIG. 4, the default set of operational settings is stored in a memory (not shown) of the processing module 54. Alternatively, the configuration information is in the form of selection information that is operative for selecting a desired set of operational settings from a plurality of sets of operational settings. In the specific example of implementation shown in FIG. 4, the plurality of sets of operational settings are stored in the memory of the processing module 54.

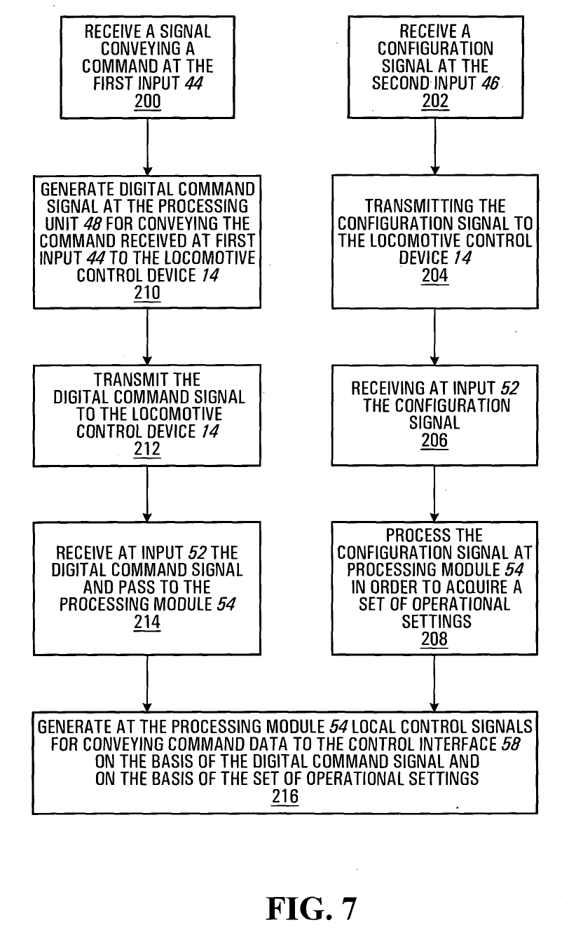

The process used by the locomotive remote control system 10 shown in FIG. 4 will now be described in more detail with respect to the flow chart shown in FIG. 7. At step 200, a signal conveying a command is received at first input 44. At step 202, configuration information is received at the second input 46. At step 204 the configuration information is transmitted from the transmission unit 50 to the locomotive control device 14. At step 206, the configuration information is received at the input 52 of the locomotive control device 14 and at step 208 the configuration information is passed to the processing module 54, which processes the configuration information in order to acquire a set of operational settings.

After having received a signal conveying commands at step 200, at step 210 the processing unit 48 of the remote control device 12 generates digital command signals on the basis of the signals received at the first input 44. At step 212, the digital command signals are passed to the transmission unit 50, which transmits the digital command signals to the locomotive control device 14. At step 214 the digital command signals are received at input 52 and are passed to the processing module 54.

At step 216, the processing module 54 of the locomotive control device generates local control signals for conveying command data to the control interface at least in part on the basis of the digital command signals and the set of operational settings. The local control signals are then sent to the control interface 58 for causing the locomotive 18 to execute the command data conveyed by the local control signals.

It should be noted that FIG. 7 shows steps 200, 210, 212 and 214 as being performed independently of steps 202, 204, 206 and 208. In other words, receiving a signal conveying a command at the first input 44 is not necessarily dependent on having received configuration information at the second input 46 and having the processing module 54 acquire a set of operational settings. It is within the scope of the invention for the remote control device 12 to receive a plurality of commands at the first input 44 and receive configuration information only once at the second input 46.

FIG. 5 shows another embodiment of the locomotive remote control system 10. As shown, the remote control device 12 includes an input 44 for receiving signals conveying commands for transmission to the locomotive 18. The locomotive control device 18 includes two inputs, namely a first input 52 for receiving signals from the remote control device 12 and a second input 53 for receiving configuration information. It should be understood that although the first and second inputs 52 and 53 are shown as being separate inputs, in an alternative embodiment, the two inputs can be the same physical input.

In the embodiment depicted in FIG. 5, the configuration information received at the second input 53 originates from an entity other than the remote control device 12. The configuration information received at second input 53 can be a wireless signal such as a radio frequency (RF) signal, or an infrared signal. In such a case, the second input 53 includes an RF or infrared receiver. In an alternative embodiment, the second input 53 can be a port for connection via cable or docking port to a programming device, such that the configuration information can be received over a wire-line communication link. In another alternative embodiment, the second input 53 can be a device for reading the configuration information from a computer readable storage medium, such as a disk or CD. In yet another alternative embodiment, the configuration information can be entered via user-operable-inputs located on the locomotive control device 14. In a non-limiting example, the locomotive control device 14 includes a user interface that includes a keyboard, buttons, toggles, switches, a touch sensitive screen, a voice recognition unit, a pointing device or any other user-operable-input device known in the art. In such a scenario, the second input 53 includes the user-operable-inputs located on the locomotive control device 14.

In yet another embodiment, the second input 53 can be an antenna for receiving the configuration information from a transponder located on the railroad track, or from an EM field generated by a portal or gate at the entrance of a switchyard. This embodiment is particularly useful for configuring the locomotive remote control system 10 such that it is suitable for use in different geographical locations, such as within different switchyards and outside a switchyard. As described above, during a typical journey for a locomotive 18, the locomotive 18 commences its journey in a first switchyard, then exits the first switchyard to travel the majority of it journey over railroad track located outside a switchyard, and then finishes its journey in a second switchyard. Typically, there will be different constraints and operating procedures depending on whether the locomotive 18 is located in the first switchyard, the second switchyard, or somewhere in between. As such, in a specific embodiment, a transponder, or portal can be positioned at the entry and exit points of these areas, such that when the locomotive 18 passes over a transponder, or in the vicinity of the portal, configuration information would be transmitted to second input 53 of the locomotive control device 14. As such, when the locomotive 18 travels over the transponder, or passes in the vicinity of the portal, the processing module 54 acquires a set of operational settings that causes the locomotive remote control system 10 to be suitable for use within the geographical location that the locomotive 18 has just entered.

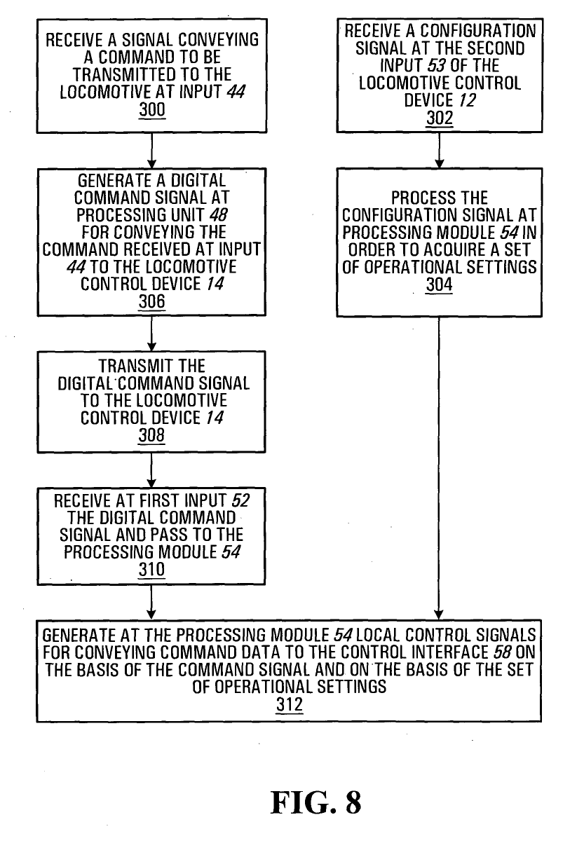

The process used by the locomotive remote control system 10 shown in FIG. 5 will now be described in more detail with respect to the flow chart shown in FIG. 8. At step 300, a signal conveying a command is received at input 44 of the remote control device 12. At step 302, configuration information is received at the second input 53 of the locomotive control device 14. At step 304 the configuration information is passed to the processing module 54, which processes the configuration information in order to acquire a set of operational settings.

After having received the signal conveying a command at step 300, at step 306 the processing unit 48 of the remote control device 12 generates digital command signals on the basis of the signals received at the first input 44. At step 308, the digital command signals are passed to the transmission unit 50, which transmits the digital command signals to the locomotive control device 14. At step 310 the digital command signals are received at input 52 and are passed to the processing module 56.

At step 312, the processing module 54 of the locomotive control device 14 generates local control signals for conveying command data to the control interface 58 at least in part on the basis of the digital command signals and the set of operational settings. The local control signals are then transmitted to the control interface by the transmission module 56 for causing the locomotive 18 to execute the command data conveyed by the local control signals.

It should be noted that FIG. 8 shows steps 300, 306, 308 and 310 as being performed independently of steps 302 and 304. In other words, receiving a signal conveying a command at the first input 44 of the remote control device 12 is not necessarily dependent on having received configuration information at the second input 53 of the locomotive control device 14 and having the processing module 54 acquire a set of operational settings. It is within the scope of the invention for the remote control device 12 to receive a plurality of commands at the first input 44 while configuration information is received only once at the second input 53 of the locomotive control device 14.

Physical Implementation

Those skilled in the art should appreciate that in some embodiments of the invention, all or part of the functionality previously described herein with respect to the processing unit 48 and the processing module 54, may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to either of the processing unit 48 and the processing module 54 may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

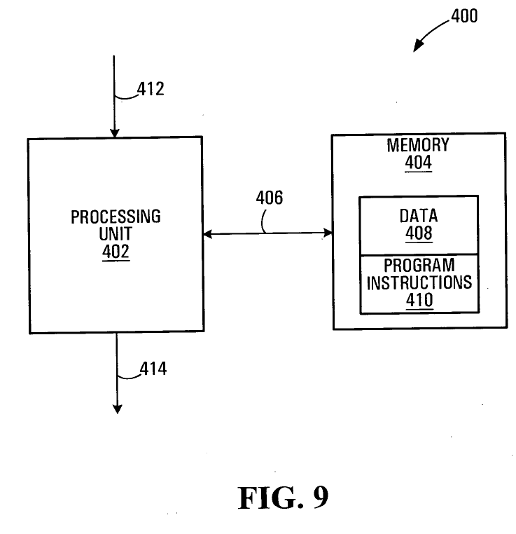

The processing unit 48 or the processing module 54 may be configured as a computing unit 400 of the type depicted in FIG. 9, including a processing unit 402 and a memory 404 connected by a communication bus 406. The memory 404 includes data 408 and program instructions 410. The processing unit 402 is adapted to process the data 408 and the program instructions 410 in order to implement the functionality described in the specification and depicted in the drawings. In a specific example of implementation, the data 408 includes one or more sets of operational settings that are accessed by the program instructions 410 for mapping a command signal with appropriate command data. The computing unit 400 may also comprise a number of interfaces 412 and 414 for receiving or sending data elements to external devices.

In a specific example of implementation, the memory 404 includes a program element contained within the program instructions 410, for execution by the computing unit 400. Once the processing unit 402 has received the configuration information, the program element is operative to process the configuration information so as to be able to acquire a set of operational settings.

Those skilled in the art should further appreciate that the program instructions 410 may be written in a number of programming languages for use with many computer architectures or operating systems. For example, some embodiments may be implemented in a procedural programming language (e.g., “C”) or an object oriented programming language (e.g., “C++” or “JAVA”).

Although the present invention has been described in considerable detail with reference to certain preferred embodiments thereof, variations and refinements are possible without departing from the spirit of the invention. Therefore, the scope of the invention should be limited only by the appended claims and their equivalents.

1. A remote control device suitable for use in a locomotive remote control system, the locomotive remote control system having a locomotive control device mounted on board a locomotive, said remote control device comprising:
a first input for receiving from a user a signal conveying a command;
a second input for receiving configuration information;
a processing unit in communication with said first input and said second input, said processing unit being adapted for:
a) acquiring a certain set of operational settings on the basis of said configuration information;
b) generating digital command signals on the basis of the signal received at said first input and said certain set of operational settings, said digital command signals conveying command data to the locomotive control device;
a transmission unit in communication with said processing unit for receiving the digital command signals and for generating an RF transmission conveying the digital command signals to the locomotive control device.

2. A remote control device as defined in claim 1, wherein said configuration information includes programming information, said programming information being operative for modifying a default set of operational settings to derive said certain set of operational settings.

3. A remote control device as defined in claim 1, wherein said configuration information is operative for selecting said certain set of operational settings from a plurality of sets of operational settings.

4. A remote control device as defined in claim 3, wherein each set of operational settings in the plurality of sets of operational settings is associated to a respective user of the remote control device, and wherein said configuration information is indicative of user identification data.

5. A remote control device as defined in claim 3, wherein each set of operational settings in the plurality of sets of operational settings is associated to a certain geographical location.

6. A remote control device as defined in claim 5, wherein a set of operational settings in the plurality of operational settings is associated to a switchyard condition.

7. A remote control device as defined in claim 1, wherein said certain set of operational settings includes a setting associated to a parameter selected from the list consisting of speed, transmission frequency, repetition rate, repetition pattern, clock information, permission level, and horn sound.

8. A remote control device as defined in claim 1, wherein said second input is an RF input for receiving said configuration information over a wireless communication link.

9. A remote control device as defined in claim 1, wherein said second input is a user activated input for enabling a user to enter said configuration information.

10. A remote control device as defined in claim 1, wherein said remote control device is a portable unit.

11. A locomotive control device suitable for use in a locomotive remote control system and adapted for being mounted in a locomotive having a control interface, said locomotive control device comprising:
a first input for receiving from a remote control device a signal conveying a command;
a second input for receiving configuration information;
a processing module in communication with said first input and said second input, said processing module being adapted for:
a) acquiring a certain set of operational settings on the basis of said configuration information;
b) generating local control signals on the basis of the signal received at said first input and said set of operational settings, said local control signals conveying a command to be implemented by the control interface;
a transmission module in communication with said processing module for receiving the local control signals and for transmitting said local control signals to the control interface.

12. A locomotive control device as defined in claim 11, wherein said configuration information includes programming information, said programming information being operative for modifying a default set of operational settings to derive said certain set of operational settings.

13. A locomotive control device as defined in claim 11, wherein said configuration information is operative for selecting the certain set of operational settings from a plurality of sets of operational settings.

14. A locomotive control device as defined in claim 13, wherein at least some sets of operational settings in the plurality of sets of operational settings are associated to respective users of the locomotive remote control system, and wherein said configuration information is indicative of user identification data.

15. A locomotive control device as defined in claim 13, wherein at least some sets of operational settings in the plurality of sets of operational settings are associated to certain geographical locations.

16. A locomotive control device as defined in claim 15, wherein a set of operational settings in the plurality of sets of operational settings is associated to a switchyard condition.

17. A locomotive control device as defined in claim 11, wherein said certain set of operational settings includes a setting associated to a parameter selected from the list consisting of speed, transmission frequency, repetition rate, repetition pattern, clock information, permission level, and horn sound.

18. A locomotive control device as defined in claim 11, wherein said first input and said second input are the same physical input.

19. A locomotive control device as defined in claim 11, wherein said second input is an RF input for receiving said configuration information over a wireless communication link.

20. A remote control device suitable for use in a locomotive remote control system, the locomotive remote control system having a locomotive control device mounted on board a locomotive, said remote control device comprising:
a user interface for enabling a user to enter a signal conveying a command;
an input for receiving configuration information;
a processing unit in communication with said input, said processing unit being adapted for causing said user interface to acquire a certain set of display settings on the basis of said configuration information.

21. A remote control device as defined in claim 20, wherein said configuration information includes programming information, said programming information being operative for modifying a default set of display settings of said user interface in order to derive said certain set of display settings.

22. A remote control device as defined in claim 20, wherein said configuration information is operative for selecting said certain set of display settings from a plurality of sets of display settings.

23. A remote control device as defined in claim 22, wherein each set of display settings in the plurality of sets of display settings is associated to a respective user of the remote control device, and wherein said configuration information is indicative of user identification data.

24. A remote control device as defined in claim 22, wherein each set of display settings in the plurality of sets of display settings is associated to a certain geographical location.

25. A remote control device as defined in claim 20, wherein said set of display settings include a setting associated to a display element selected from the set consisting of an icon, background colour, night vision and speed settings.

26. A remote control device as defined in claim 20, wherein said input is an RF input for receiving said configuration information over a wireless communication link.

27. A remote control device as defined in claim 20, wherein said remote control device is a portable unit.

28. A locomotive remote control system, comprising:
a remote control device having:
a) a first input for receiving from a user a signal conveying a command;
b) a second input for receiving configuration information;
c) a processing unit in communication with said first input and said second input, said processing unit being adapted for:
1. acquiring a set of operational settings on the basis of said configuration information;
2. generating digital command signals on the basis of the signal received at said first input and said set of operational settings, said digital command signals conveying command data to the locomotive control device;
3. a transmission unit in communication with said processing unit for receiving the digital command signals and for generating an RF transmission conveying the digital command signals to a locomotive control device;
a locomotive control device suitable for mounting on board a locomotive, said locomotive control device comprising:
a) an input for receiving the digital command signals;
b) a processing module for generating local control signals for causing the locomotive to execute commands conveyed by the digital command signals.

29. A remote control device suitable for use in a locomotive remote control system, the locomotive remote control system having a locomotive control device mounted on board a locomotive, said remote control device comprising:
input means for receiving from a user a signal conveying a command and for receiving configuration information;
processing means adapted for:
a) acquiring a set of operational settings on the basis of said configuration information;
b) generating digital command signals on the basis of the signal conveying a command and said set of operational settings, said digital command signals conveying command data to the locomotive control device;
transmission means for receiving the digital command signals and for generating an RF transmission conveying the digital command signals to the locomotive control device.

30. A remote control device suitable for use in a locomotive remote control system, the locomotive remote control system having a locomotive control device mounted on board a locomotive, said remote control device comprising:
a first input for receiving a signal from a user conveying a command;
a second input for receiving configuration information;
a processing unit in communication with said first input and said second input, said processing unit being adapted for:
a) acquiring a certain set of switchyard operational settings on the basis of said configuration information;
b) generating digital command signals on the basis of the signal received at said first input and said certain set of switchyard operational settings, said digital command signals conveying command data to the locomotive control device;
a transmission unit in communication with said processing unit for receiving the digital command signals and for generating an RF transmission conveying the digital command signals to the locomotive control device.

31. A remote control device suitable for use in a locomotive remote control system, the locomotive remote control system having a locomotive control device mounted on board a locomotive, said remote control device comprising:
a first input for receiving from a user a signal conveying a command;
a second input for receiving configuration information;
a processing unit in communication with said first input and said second input, said processing unit being adapted for:
a) acquiring a certain set of user related operational settings on the basis of said configuration information;
b) generating digital command signals on the basis of the signal received at said first input and said certain set of user related operational settings, said digital command signals conveying command data to the locomotive control device;
a transmission unit in communication with said processing unit for receiving the digital command signals and for generating an RF transmission conveying the digital command signals to the locomotive control device.

32. An apparatus suitable for configuring a locomotive remote control system, the locomotive remote control system having a remote control device and a locomotive control device, said apparatus comprising:
a processing unit for storing configuration information relating to at least one set of operational settings;
a transmission unit operative for:
a) establishing a communication link with the remote control device;
b) transmitting the configuration information to the remote control device over the communication link, said configuration information causing the remote control device to acquire a certain set of operational settings.

33. An apparatus as defined in claim 32, wherein said configuration information includes programming information, said programming information being operative for modifying a default set of operational settings stored at the remote control device.

34. An apparatus as defined in claim 32, wherein said configuration information is operative for selecting said certain set of operational settings from a plurality of sets of operational settings stored at the remote control device.

35. An apparatus as defined in claim 32, wherein said certain set of operational settings includes a setting associated to a parameter selected from the list consisting of speed, transmission frequency, repetition rate, repetition pattern, clock information, permission level, and horn sound.

36. An apparatus as defined in claim 1, wherein said communication link is an RF link for transmitting said configuration information over a wireless communication link.

37. An apparatus as defined in claim 1, wherein said communication link is a wire-line link for transmitting said configuration information over a wire-line communication link.

38. An apparatus suitable for configuring a locomotive remote control system, the locomotive remote control system having a remote control device and a locomotive control device, said apparatus comprising:
a processing unit for storing configuration information relating to at least one set of operational settings;
a transmission unit operative for:
a) establishing a communication link with the locomotive control device;
b) transmitting the configuration information to the locomotive control device over the communication link, said configuration information causing the locomotive control device to acquire a certain set of operational settings.
